(19) United States
(12) Patent Application Publication
(10) Pub. No.: US 2004/0118234 A1
(43) Pub. Date: Jun. 24, 2004

(54) Gear box

(76) Inventor: William R. Cole, Plainfield, IN (US)

Correspondence Address: WILLIAM R. COLE, 8760 S. C.R. 825 E., PLAINFIELD, IN, 46168, US

(21) Appl. No.: 10/716,255

(22) Filed: Nov. 18, 2003

Related U.S. Application Data
(60) Provisional application No. 60/427,763, filed on Nov. 20, 2002.

(51) Int. Cl. F16H 1/02

(52) U.S. Cl. 74/412 R

(57) ABSTRACT

A compact planetary drive provides a high reduction ratio and high torque capacity, that is economical to use.

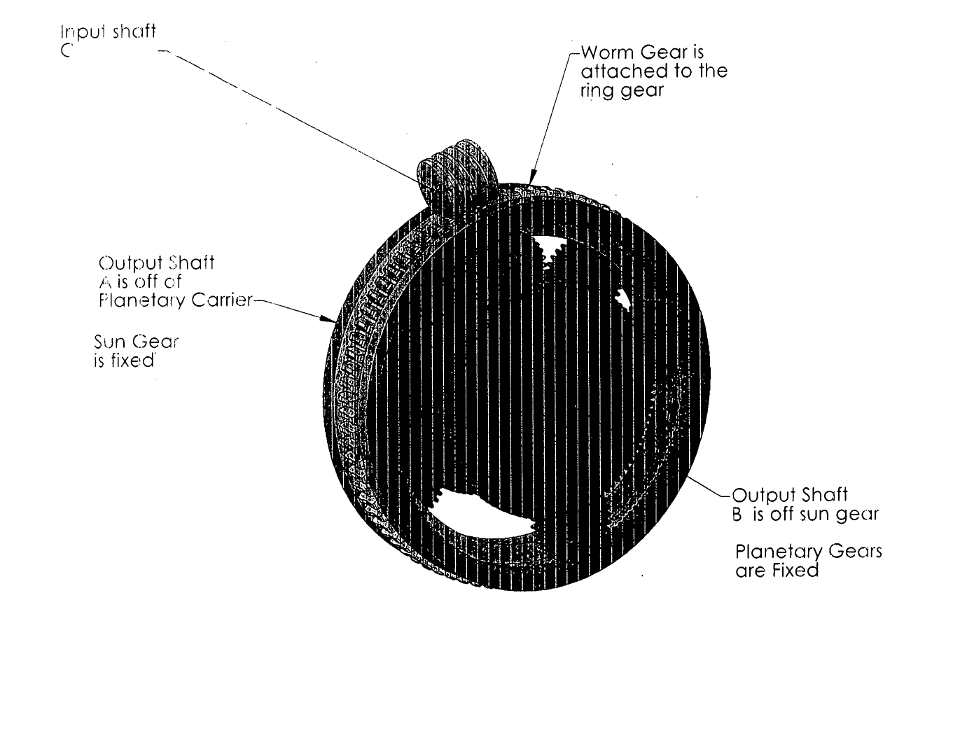

The Gear Box contains two planetary gears and a worm gear inside of a steel housing. In addition there are two output shafts which are counter rotating. Also, this design allows the user to have a high reduction ratio in one gear case.

### SUMMARY OF INVENTION

The first objective of the present invention is to provide a planetary drive with a high reduction ratio and high torque capacity, that is inexpensive and compact. One of the main objectives is to obtain counter rotating shafts coming out of the gear box.

### BRIEF DESCRIPTION OF DRAWING

Drawing 1, is a drawing of a gear box that has counter rotating shafts for the output.

1. The Gear Box is adaptable for all rpms

2. The Gear Box is a complete reduction gear assembly

3. The Gear Box also has the capability of giving counter rotation to the output shafts A & B

4. We have examined U.S. Pat. Nos. 4,417,485; 4,429,594, 4,440,044; 4,249,431 and 4,733,579

5. Disclaimer: The color shown on the claimed design/drawing forms no part thereof
